(19) United States
(12) Patent Application Publication
(10) Pub. No.: US 2009/0069528 A1
(43) Pub. Date: Mar. 12, 2009

(54) OPTICALLY-DRIVEN ACTUATOR, METHOD OF MANUFACTURING OPTICALLY-DRIVEN ACTUATOR, CONDENSATION POLYMER AND FILM

(75) Inventors: Takayasu Yasuda, Minami-Ashigara (JP); Naoyuki Nishikawa, Shizuoka (JP)

Correspondence Address: GREER, BURNS & CRAIN, 300 S WACKER DR, 25TH FLOOR, CHICAGO, IL, 60606, US

(73) Assignee: FUJIFILM CORPORATION, Tokyo (JP)

(21) Appl. No.: 12/096,559

(22) PCT Filed: Dec. 6, 2006
(86) PCT No.: PCT/JP2006/324784

§ 371 Date: Jun. 6, 2008

(30) Foreign Application Priority Data
Dec. 7, 2005 (JP) 2005-353761

(51) Int. Cl. C08G 69/00; C08G 18/00; B29D 11/00

(52) U.S. Cl. 528/85; 528/271; 264/2.7

(57) ABSTRACT

An optically-driven actuator includes a condensation polymer containing, on its backbone chain, a photoisomerizable group that undergoes structural change under optical stimulation and deforming depending on the structural change of the photoisomerizable group. The condensation polymer deforms under optical stimulation and is functional as an actuator.

### TECHNICAL FIELD

The present invention relates to an optically-driven actuator that deforms under optical stimulation and a method of manufacturing the same. The present invention also relates to a polymer used in the optically-driven actuator.

### BACKGROUND ART

There have been increasing demands in the fields of medical instruments, industrial robots, micromachines, etc. for small size, light weight and flexible actuators.

Polymer actuators in particular have attracted considerable attention because of their flexibility, light weight, and noiselessness at the time of being driven. Of the polymer actuators, optically-driven actuators that are driven by light are capable of supplying energy in a non-contact manner, do not need wiring for driving and are capable of avoiding noises generated in electric wiring, and therefore, their application particularly to industrial robots or micromachines used in the medical/nursing fields or aerospace field has been expected.

Studies on photoresponsive gels, as polymer materials that are driven under optical stimulation, have been actively conducted. For example, optical deformation of polyacrylamide gels containing the leuco form of a triphenylmethane, which is photoionizable, (Macromolecules, vol. 19, p. 2476 (1986)) and bending behavior of polyacrylamide gels when they are exposed to CO₂ infrared laser (J. Chem. Phys., vol. 102, p. 551 (1995)) have been realized. The deformation in the former example is due to the swelling of the gel caused by the increase in osmotic pressure of the gel which results from the optically induced ion-dissociation reaction. The bending behavior in the latter example is caused by the change in osmotic pressure of the gels which results from the volume change due to the heat generated by the infrared laser radiation. Besides polyacrylamide gels, polyimide gels that contain an azobenzene group, as a photoisomerizable group, on its backbone chain have also been known (Japanese Patent Laid-Open No. 2005-23151). In such photoresponsive gels, however, the principle upon which they are driven is uptaking/discharging the molecules of a solvent, for example, water caused by a change in osmotic pressure across the gels, and therefore, a solvent is indispensable to drive the gels. Thus, such gels have presented the problem of being unfunctional in the dry environment.

For polymer materials that are driven under optical stimulation in the dry environment, a phenomenon was reported a long time ago that polyimides containing an azobenzene group contracted when exposed to ultraviolet light (Macromolecules, vol. 3, p. 349 (1970)). Such polymer materials are, however, problematic, when used as an actuator, in that they are driven only at high temperatures, their response speed is very low, and their contraction rate is very small.

Liquid crystal elastomer has lately been reported as an optically-driven actuator usable in the dry environment. For example, it has been reported that liquid crystal elastomer obtained by crosslinking a polymer containing an azobenzene group, as a photoresponsive group, on its side chain in the liquid crystal alignment state shows expanding and contracting behavior and bending behavior when exposed to ultraviolet light (Japanese Patent Laid-Open No. 2005-256031; Phys. Rev. Lett. vol. 87, p. 015501 (2001), Chem. Mater. vol. 16, p. 1637 (2004)). It has also been known that polydomain liquid crystal elastomer obtained by crosslinking a polymerizable liquid crystal composition composed of an azobenzene derivative under light or heat can be bent in an arbitrary direction by exposure to polarized ultraviolet light (Nature, vol. 425, p. 145 (2003)).

However, any actuator of the above examples presents the problem of low speed of response to light and being able to function only in the form of a thin film because its response is largely decreased with increase in film thickness. Further, the actuators described in Chem. Mater. vol. 16, p. 1637 (2004) and Nature, vol. 425, p. 145 (2003) present the problem that their operating temperature or the like is limited because they are driven only in the liquid-crystal temperature range. Furthermore, forming a self-supporting thin film is complicated because the method includes the steps of: coating a substrate with a monomer composition; curing the resultant film by long-time exposure to visible light; and removing the cured film from the substrate. Thus, there have been problems left unsolved in terms not only of performance, but also of manufacturability.

In the light of the above problems, it is an object of the present invention to provide an optically driven actuator that is highly photoresponsive, flexible, lightweight, and driven noiselessly, and an easy and simple method of manufacturing the same. It is another object of the present invention to provide a good polymer used for manufacturing the optically-driven actuator and a film made up of the polymer.

### DISCLOSURE OF THE INVENTION

The optically-driven actuator of the present invention, which accomplishes the above objects, is an optically-driven actuator wherein it includes a condensation polymer that contains a photoisomerizable group, which undergoes structural change under optical stimulation, on its backbone chain and deforms depending on the structural change of the photoisomerizable group and the condensation polymer deforms depending on the optical stimulation and is functional as an actuator.

The optically-driven actuator includes a condensation polymer that contains a photoisomerizable group on its backbone chain, thereby exhibiting high photoresponsivity. Besides, the optically-driven actuator is made up of a polymer and thus it is flexible, lightweight and can be driven noiselessly.

Preferably the photoisomerizable group is an azobenzene group.

An azobenzene group is a photoisomerizable group that usually exists in the trans form, which is the thermodynamically stable form, but when exposed to ultraviolet light, it takes the cis form, and when exposed to visible light, again it takes the trans form. Thus, using an azobenzene group as a photoisomerizable group makes it easy to cause an optical isomerization reaction, thereby very high photoresponsivity can be obtained.

Preferably the azobenzene group is represented by the following general formula (1).

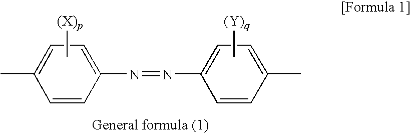

In the above formula, X and Y each represent a substituent, other than a hydrogen atom, which can be substituted on the phenyl group. p and q each represent an integer of 0 to 4, provided that p+q≠0 and when p (or q) is 2 or more, X (or Y) may be the same or different.

Introducing a substituent, other than a hydrogen atom, which can be substituted on the phenyl group of azobenzene makes it possible to properly control the physical properties of the condensation polymer.

Preferably at least one of the substituents X and Y in the general formula (1) is a branched alkyl group.

Introducing a branched alkyl group which can be substituted on the phenyl group of azobenzene also makes it possible to properly control the physical properties of the condensation polymer.

Preferably the condensation polymer according to the present invention is anyone selected from the group consisting of polyesters, polyamides, polyurethanes and polycarbonates.

The optically-driven actuator of the present invention does not require a mechanism that utilizes the swelling of a solvent to drive an actuator, and thus it can be driven at a high speed.

Preferably the optically-driven actuator according to the present invention is formed into a film.

An optically-driven actuator formed into a film is more processable.

Preferably the optically-driven actuator according to the present invention is formed into a film and stretched.

Such an optically-driven actuator is more processable and more photoresponsive.

A method of manufacturing an optically-driven actuator is provided which includes a polymer that deforms under optical stimulation and utilizing the deformation of the polymer for an actuator, the method including the steps of:

forming a film from a composition that contains a condensation polymer having a photoisomerizable group on its backbone chain; and.

stretching the composition that contains the condensation polymer.

According to the method of manufacturing an optically-driven actuator of the present invention, an optically-driven actuator is easily manufactured whose processability is enhanced by forming such a composition into film and whose photoresponsivity is enhanced by stretching the composition formed into film.

The condensation polymer is a polymer that contains a photoisomerizable group, which undergoes structural change under optical stimulation, on its backbone chain, deforms depending on the structural change of the photoisomerizable group, and has a repeating unit represented by the following general formula (2):

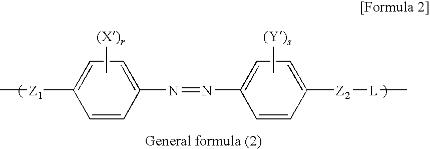

In the above formula, X′ and Y′ each represent a substituent, other than a hydrogen atom, which can be substituted on the phenyl group and at least one of X′ and Y′ is a branched alkyl group. r and s each represent an integer of 0 to 4, provided that r+s≠0 and when r (or s) is 2 or more, X′ (or Y′) may be the same or different. L represents a divalent linking group or a single bond. Z₁ represents a divalent linking group selected from the group consisting of —OC(═O)—, —OC(═O)NR¹—, —C(═O)NR¹—, where R¹ is a hydrogen atom or optionally substituted alkyl group. These divalent linking groups may be linked in either direction, and Z₂ represents a divalent substituent linked in the direction opposite to Z₁.

Employing a condensation polymer that has a repeating unit represented by the general formula (2) makes it possible to properly control the physical properties of the condensation polymer.

The condensation polymer according to the present invention is formed into film.

The condensation polymer according to the present invention is more processable since it is formed into film.

According to the present invention, an optically-driven actuator that is highly photoresponsive, flexible, light weight, and is driven noiselessly as well as an easy and simple method of manufacturing the same can be provided. A good polymer used for manufacturing the optically-driven actuator and a film made up of the polymer can also be provided.

### BRIEF DESCRIPTION OF THE DRAWINGS

FIG. 1 is a flow chart illustrating one embodiment of the method of manufacturing an optically-driven actuator of the present invention.

FIG. 2 is a diagram illustrating the evaluation experiment of photoresponsivity for the second optically-driven actuator in Example 5 of the present invention.

### BEST MODE FOR CARRYING OUT THE INVENTION

In the following embodiments of the present invention will be described.

After intensive investigation, the present inventors have found that a condensation polymer having a photoisomerizable group on its backbone chain can be a good material for optically-driven actuators which shows high photoresponsivity and has good processability.

The optically-driven actuator of the present invention includes a condensation polymer having a photoisomerizable group on its backbone chain (hereinafter sometimes referred to as photoresponsive condensation polymer). The term “photoisomerizable group” used herein means a functional group that undergoes stereoisomerization or structural isomerization by light and preferably undergoes reverse isomerization by light having a different wavelength or heat. Of the compounds that have such a functional group and undergo structural change and color tone changes in the visible range, many are known as a photochromic compound. Specific examples of such compounds include: azobenzenes, benzaldoximes, azomethines, stilbenes, spiropyrans, spirooxazines, fulgides, diaryl ethenes, cinnamic acids, retinals and hemithioindigos.

The term “condensation polymers” used herein means polymers that can be synthesized by polycondensation or polyaddition; however, polymers obtained by cyclic polycondensation or cyclic polyaddition (e.g. polyimides, polybenzoazoles, polyoxazoles, polypyrazoles and polyisooxazolines) are excluded in the present invention, because their polymer structure is rigid, and therefore, they are not preferable from the viewpoint of photoresponsivity.

Of the photoisomerizable groups, azobenzene groups are preferable, and particularly one represented by the following general formula (1) is preferable.

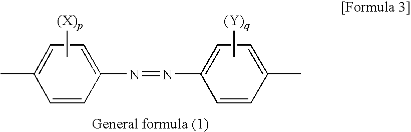

In the above formula, X and Y each represent a substituent, other than a hydrogen atom, that can be replaced on the phenyl group. Specific examples of substituents represented by X or Y include: halogen atoms; and alkyl (including cycloalkyl), alkenyl (including cycloalkenyl, bicycloalkenyl), alkynyl, aryl, heterocyclic, cyano, hydroxyl, nitro, alkoxy, aryloxy, acyloxy, carbamoyloxy, amino (including anilino), acylamino, sulfamoylamino, mercapto, alkylthio, arylthio, acyl, aryloxycarbonyl, alkoxycarbonyl and carbamoyl groups. Of these atoms or groups, halogen atoms and alkyl, alkenyl, aryl, alkoxy, acyloxy and alkoxycarbonyl groups are preferable, alkyl groups are more preferable, branched alkyl groups (for example, isopropyl, sec-butyl and t-butyl groups) are still more preferable, and a t-butyl group is most preferable.

P and q each represent an integer of 0 to 4, provided that p+q≠0 and when p (or q) is 2 or more, X (or Y) may be the same or different.

The photoisomerizable group may be included not only on the backbone chain, but on the side chain or crosslinked group of the condensation polymer.

Examples of the photoresponsive condensation polymer include: polyethers, polysulfides, polysiloxanes, polyesters, polyamides, polycarbonates, polyurethanes, polysulfonates and polyphosphonates.

Of these condensation polymers, polyesters, polyamides, polyurethanes and polycarbonates are preferable, and polyesters are most preferable.

The structures, other than the photoisomerizable groups, that can be included in the above photoresponsive condensation polymers are not limited to any specific ones. Various functional groups can be introduced as backbone or side chain components so as to properly control the physical properties of the polymer.

Preferred examples of the photoresponsive condensation polymers include polymers having a repeating unit represented by the following general formula (2).

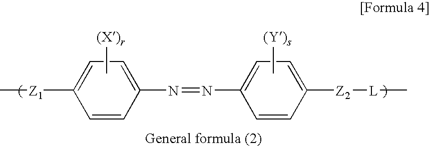

In the general formula (2), X′ and Y′ each represent a substituent, other than a hydrogen atom, which can be substituted on the phenyl group and at least one of X′ and Y′ is a branched alkyl group. Specific examples of X′ and Y′ include the same as those of X and Y in the general formula (1). r and s each represent an integer of 0 to 4, provided that r+s≠0 and when r (or s) is 2 or more, X′ (or Y′) may be the same or different.

L represents a divalent linking group or a single bond and preferably it is a divalent linking group. Preferably the divalent linking group is an optionally substituted alkylene group, optionally substituted arylene group, a divalent linking group represented by the following general formula (3), —O—, —C(═O)—, —N(R²)—, —S—, —S(═O)—, —SO₂—, or a divalent linking group formed by combining 2 or more kinds of groups selected from the above, where R² represents a hydrogen atom or an optionally substituted alkyl group.

As an alkylene group, one having 2 to 18 carbon atoms is preferable and one having 4 to 12 carbon atoms is more preferable. As an arylene group, one having 6 to 24 carbon atoms is preferable, one having 6 to 18 carbon atoms is more preferable and one having 6 to 12 carbon atoms is much more preferable. Most preferable specific examples of arylene groups include phenylene and naphthalene groups.

Most preferably L is an optionally substituted alkylene group, a divalent linking group represented by the following general formula (3) or a divalent linking group formed by combining these linking groups.

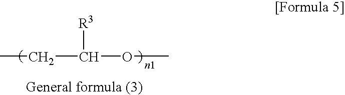

In the above general formula (3), R³ represents a hydrogen atom or a methyl group. The number of the repeating unit n1 is preferably 1 to 25 and more preferably 1 to 10.

Z₁ represents a divalent linking group selected from the group consisting of —OC(═O)—, —OC(═O)NR¹—, —C(═O)NR¹—, where R¹ is a hydrogen atom or an optionally substituted alkyl group. These divalent linking groups may be linked in either direction, and Z₂ represents a divalent substituent linked in the direction opposite to Z₁ (for example, when Z₁=—OC(═O)—, Z₂=—C(═O)O—).

For processes for synthesizing various kinds of condensation polymers, reference can be made to the processes described in “New Experimental Polymer Science 3, Synthesis/Reaction of Polymers (2), Synthesis of Condensation Polymers”, Chapter 2 and 3, edited by the Society of Polymer Science, Japan, published by Kyoritsu Shuppan Co., Ltd., 1996. Particularly for processes for synthesizing polyesters, polyamides and polyurethanes, reference can be made to the document pp. 77-95, pp. 57-77 and pp. 229 to 233, respectively. In synthesis of polyesters or polyamides, the interfacial polycondensation process is preferably used because the process allows higher molecular-weight polymers to be produced under moderate conditions.

Preferably the amount of the photoisomerizable group contained in the photoresponsive condensation polymer is 0.1 mmols/g to 10 mmols/g and more preferably 0.5 mmols/g to 8 mmols/g in terms of the number of moles of the functional group per unit mass of the polymer.

The mass average molecular weight of the photoresponsive condensation polymer is generally 5,000 to 500,000, preferably 8,000 to 300,000 and more preferably 10,000 to 200,000. The photoresponsive condensation polymer having a mass average molecular weight in such a range is preferable because it offers a good balance of mechanical strength and moldability. The mass average molecular weight can be determined using gel permeation chromatography (GPC) in terms of polystyrene (PS).

In the following, specific examples of photoresponsive condensation polymers preferably used in the present invention will be described; however, it should be understood that these examples are not intended to limit the present invention. The values in the following formulae (e.g. values a, b) are mole percentages that show the contents of the structural units and Mw represents a mass average molecular weight determined, in terms of polystyrene, using a GPC analyzer with columns TSK Gel GMHXL, TSK Gel G4000 H×L and TSK Gel G2000 H×L (trade names, all manufactured by Tosoh Corporation) and THF as a solvent, by differential refractometer. However, since P-14 to P-18 and P-22 to P-25 are poorly soluble in THF, their viscosity, as an index related to molecular weight, is determined. In the examples of photoresponsive condensation polymers below, ηᵢₙₕ represents a viscosity (inherent viscosity) determined using an automatic viscometer (VMC-252, manufactured by Rigo Co., Ltd.) with a Ubbelohde capillary kinematic viscometer.

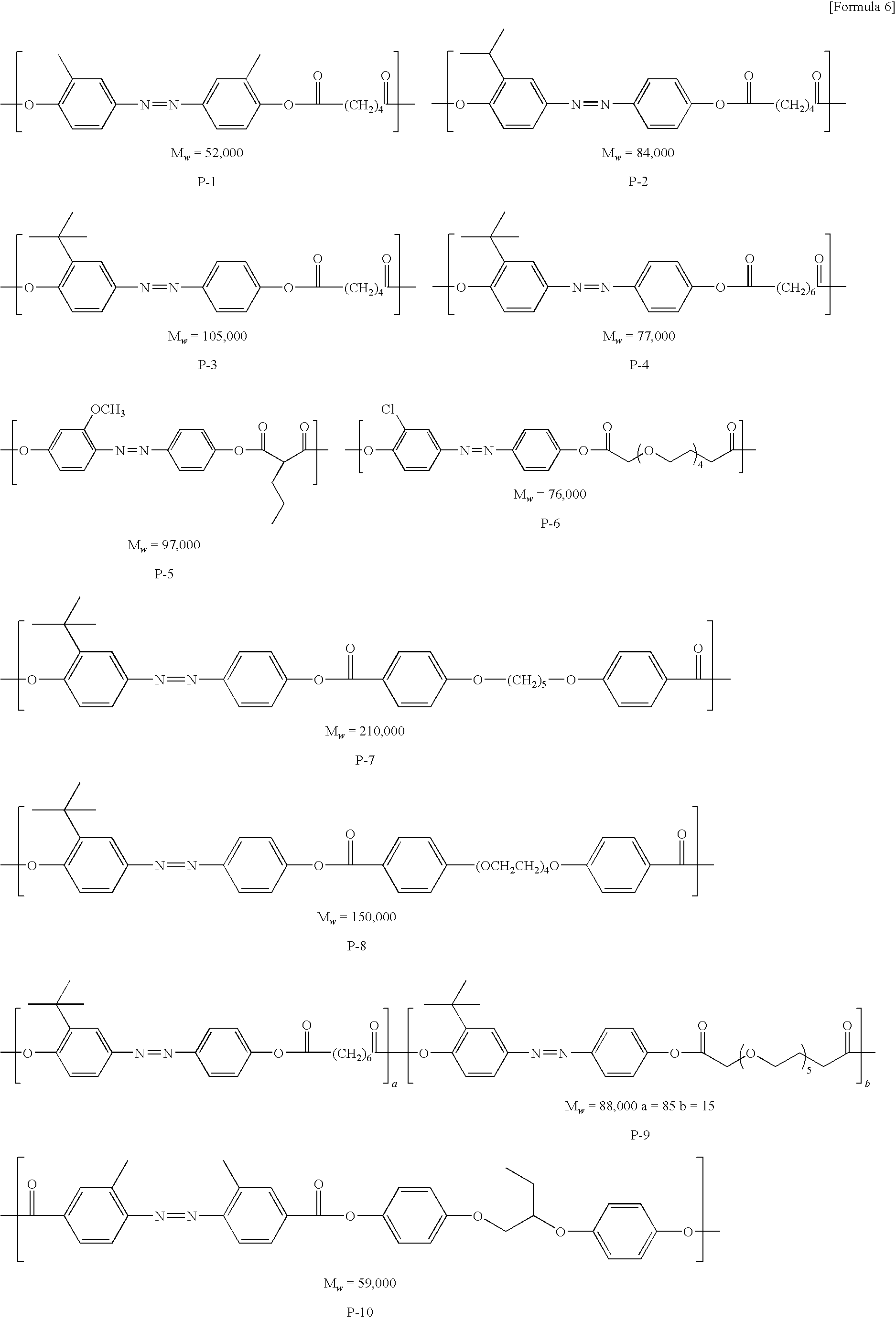

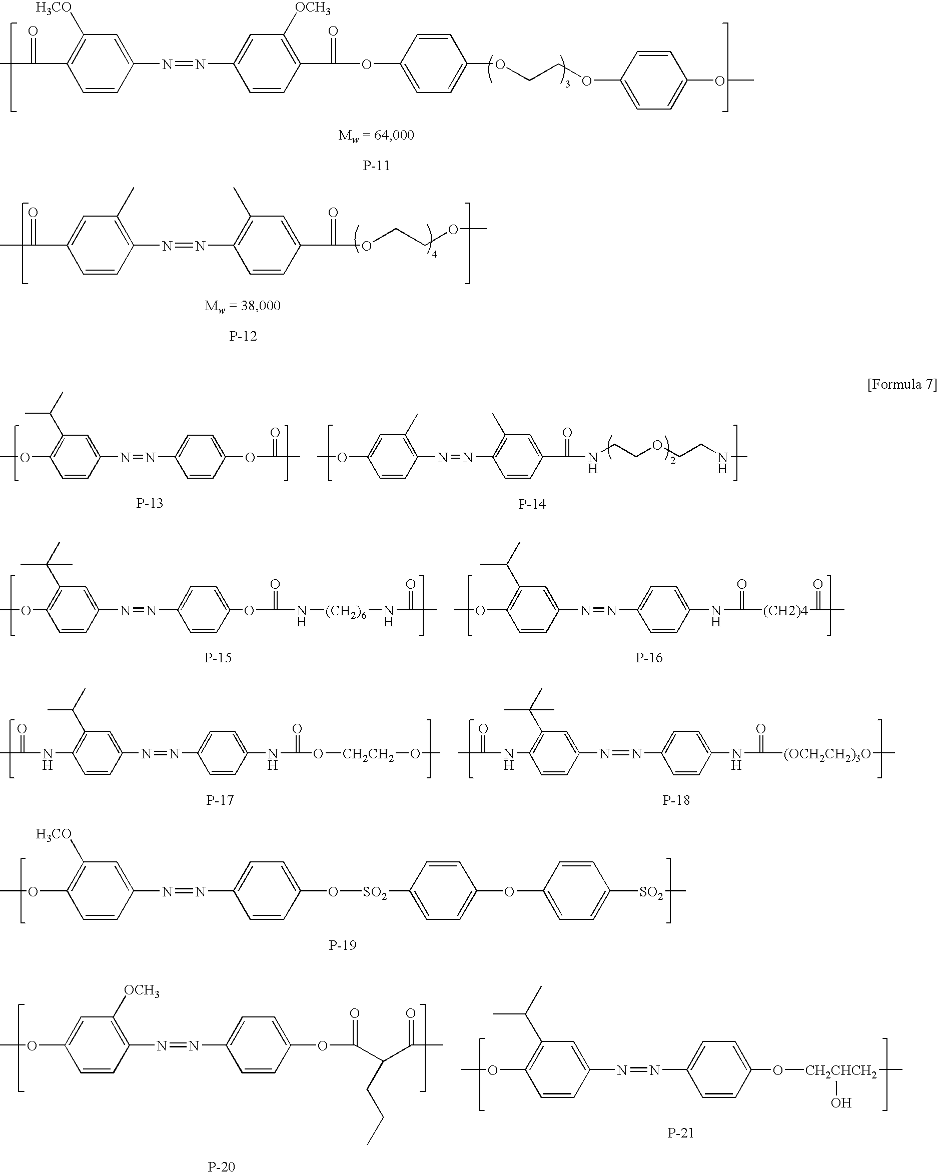

### P-13: M_{w}=61,000

P-14: ηᵢₙₕ=0.7 (dl/g)
(solvent: dimethylacetamide containing 5 wt % lithium chlo ride, concentration: 0.3 g/dl)
P-15: ηᵢₙₕ=1.0 (dl/g)
(solvent: dimethylacetamide containing 5 wt % lithium chlo ride, concentration: 0.3 g/dl)
P-16: ηᵢₙₕ=0.9 (dl/g)
(solvent: dimethylacetamide containing 5 wt % lithium chlo ride, concentration: 0.3 g/dl)
P-17: ηᵢₙₕ=1.1 (dl/g)
(solvent: dimethylacetamide containing 5 wt % lithium chlo ride, concentration: 0.3 g/dl)
P-18: ηᵢₙₕ=0.8 (dl/g)
(solvent: dimethylacetamide containing 5 wt % lithium chlo ride, concentration: 0.3 g/dl)

### P-19: M_{w}=82,000

### P-20: M_{w}=97,000

### P-21: M_{w}=76,000

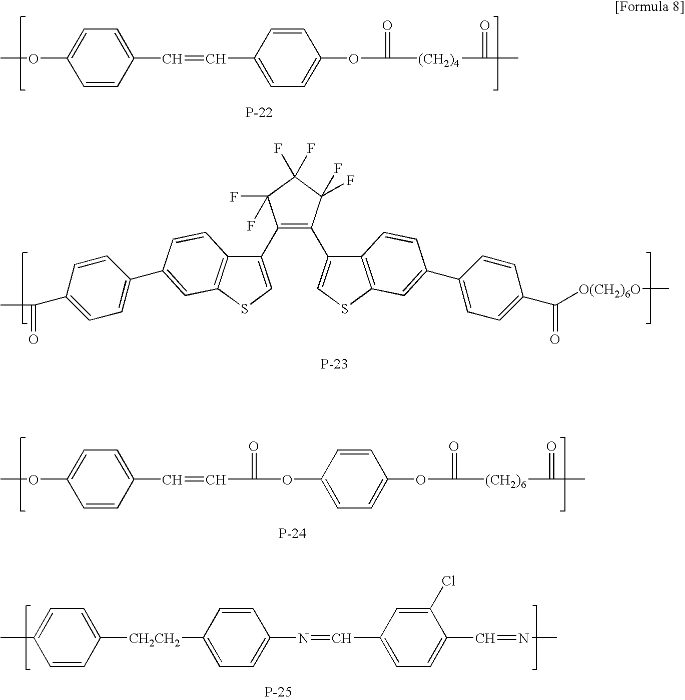

P-22: ηᵢₙₕ=1.0 (dl/g)
(solvent: o-chlorophenol, concentration: 0.5 g/dl)
P-23: ηᵢₙₕ=0.9 (dl/g)
(solvent: sym-tetrachloroethane/phenol (weight ratio 60/4 0), concentration: 0.5 g/dl)
P-24: ηᵢₙₕ=0.9 (dl/g)
(solvent: o-chlorophenol, concentration: 0.5 g/dl)
P-25: ηᵢₙₕ=0.9 (dl/g)
(solvent: concentrated sulfuric acid, concentration: 0.5 g/dl)

The optically-driven actuator of the present invention may contain two or more of the photoresponsive condensation polymers. It may also contain various kinds of polymers other than the photoresponsive condensation polymers so as to control the thermophysical properties such as glass transition temperature or mechanical properties such as modulus of elasticity. Further, various kinds of additives such as thermal stabilizers, antiaging agents, antioxidants, light stabilizers, plasticizers, softening agents, flame-retardants, pigments, foaming agents or foaming auxiliaries may also be used if necessary.

In the following the method of manufacturing the optically-driven actuator of the present invention will be described in detail.

The optically-driven actuator of the present invention can be formed from the composition containing any one of the photoresponsive condensation polymers by known and commonly used process, which has been reported as polymer forming means. Examples of means of forming polymers into film include a process of forming a film from polymer in the solution state and a process of forming a film from polymer in the molten state.

As a process of forming a film from polymer in the solution state, a curtain coating, extrusion coating, roll coating, spin coating, dip coating, bar coating, spray coating, slide coating or print coating process can be used.

As a solvent for the coating fluid used in the process of forming a film from polymer in the solution state, known solvents in which a composition containing the photoresponsive condensation polymer can be dissolved or dispersed can be used. Specific examples of such solvents include: halogen solvents such as chloroform and dichloromethane; ketone solvents such as methyl ethyl ketone and cyclohexanone; and amide solvents such as dimethylformamide and dimethylacetamide. Of these solvents, chloroform, methyl ethyl ketone, cyclohexanone and dimethylacetamide are preferable, and chloroform, methyl ethyl ketone, and dimethylacetamide are particularly preferable. These solvents may be used in combination.

Bases used in the process of forming a film from polymer in the solution state are not limited to specific ones; however, bases which are not swelled by or dissolved in the coating solvent are preferable. For drying the coating, any known drying process can be used. Specific examples include room temperature drying, heat drying, blast drying and vacuum drying. Two or more of these drying processes may be used in combination.

The dried coating may be separated from the base or may be used together with the base as an optically-driven actuator if the base is highly flexible.

As a process of forming a film from polymer in the molten state, hot-melt pressing or melt extruding can be used. Examples of hot-melt pressing include: batch processes such as flat plate pressing and vacuum pressing; and continuous processes such as continuous roll pressing.

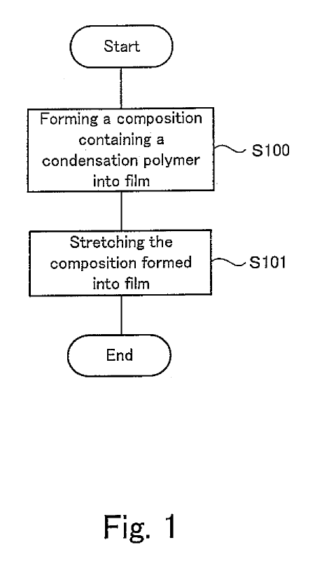

FIG. 1 is a flow chart illustrating one embodiment of the method of manufacturing an optically-driven actuator of the present invention.

As a first step, a composition that contains a condensation polymer having a photoisomerizable group on its backbone chain is formed into film (step S100).

Then, as a second step, the composition, which contains a condensation polymer having a photoisomerizable group on its backbone chain, formed into film is stretched (step S101).

The optically-driven actuator of the present invention is manufactured in these steps.

Preferably the optically-driven actuator of the present invention is stretched uniaxially or biaxially under stress after being formed into film or during the film formation. For stretching, stretching while heating, stretching while controlling humidity, or stretching while heating under controlled humidity may be used. Stretching while heating or stretching while heating under controlled humidity is preferable. The degree of stretching is preferably 1.01 to 10 and more preferably 1.1 to 5.

The light source used when driving the optically-driven actuator of the present invention is not limited to any specific one, as long as it has wavelength suitable for the photoresponsive group used. The light to be radiated may be polarized light or non-polarized light.

### EXAMPLES

The present invention will be described in further detail by the following examples; however, it is to be understood that these examples are not intended to limit the present invention.

### Example 1

### Synthesis of Photoresponsive Condensation Polymer P-4

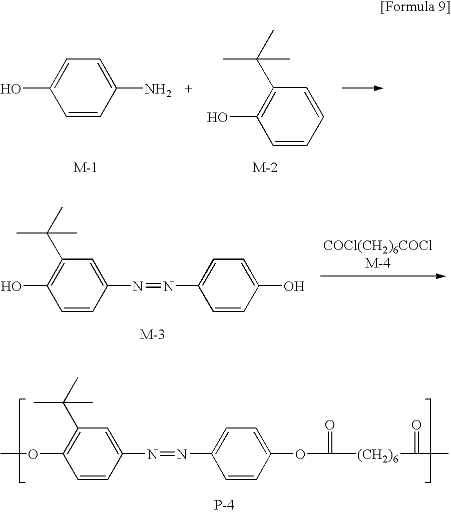

To an aqueous solution prepared by adding 90 ml of water to 22 ml of an aqueous solution of 37% by weight of hydrochloric acid, M-1 (10.91 g, 0.100 mols) was added and cooled to 5° C. or lower. To this solution, an aqueous solution prepared by dissolving 7.59 g of sodium nitrite in 22 ml of water was added dropwise (internal temperature was 5° C. or lower). The mixed solution was stirred for 30 minutes while keeping the internal temperature at 5° C. to 10° C. The resultant solution was added dropwise to a solution of M-2 (15.02 g, 0.100 mol) in an aqueous solution of sodium hydroxide (sodium hydroxide: 16.12 g, water: 90 ml), while keeping the internal temperature at 5° C. or lower, and the mixed solution was stirred for 30 minutes. The resultant reaction product was added to an aqueous solution of 1 N hydrochloric acid (1.5 L), and the produced precipitate was filtered out and washed with an aqueous solution of sodium hydrogencarbonate and water. After drying, the precipitate was purified by silica gel column chromatography (solvent: hexane/ethyl acetate (3/1 (v/v))) to yield M-3 (20.67 g, 76.5 mmol).

M-3 (2.703 g, 10 mmol) was dissolved in an aqueous solution of sodium hydroxide (sodium hydroxide: 0.81 g, water: 100 ml), and to the resultant solution, tetra-n-butylammonium chloride (1.60 g, 5.76 mmol) was added. Then, a solution prepared by dissolving M-4 (2.111 g, 10 mmol) in 1,2-dichloroethane (30 ml) was added dropwise over 30 minutes, while vigorously stirring the M-3 solution, and stirred vigorously for another 30 minutes. To the resultant reaction product, 20 ml of methylene chloride was added so as to separate the organic layer. The separated organic layer was washed with an aqueous solution of saturated sodium chloride and dried by adding magnesium sulfate. The solvent was distilled away to some extent to concentrate the organic layer, and the concentrated organic layer was added to methanol to be reprecipitated. The resultant precipitate was filtered and dried to yield P-4 (3.5 g). The weight average molecular weight of P-4 was determined, in terms of polystyrene, using GPC analyzer with columns TSK Gel GMHxL, TSK Gel G4000 H×L and TSK Gel G2000 H×L (trade names, all manufactured by Toso) and THF as a solvent, by differential refractometry. The determination was 77000.

### Example 2

### Synthesis of Photoresponsive Condensation Polymer P-9

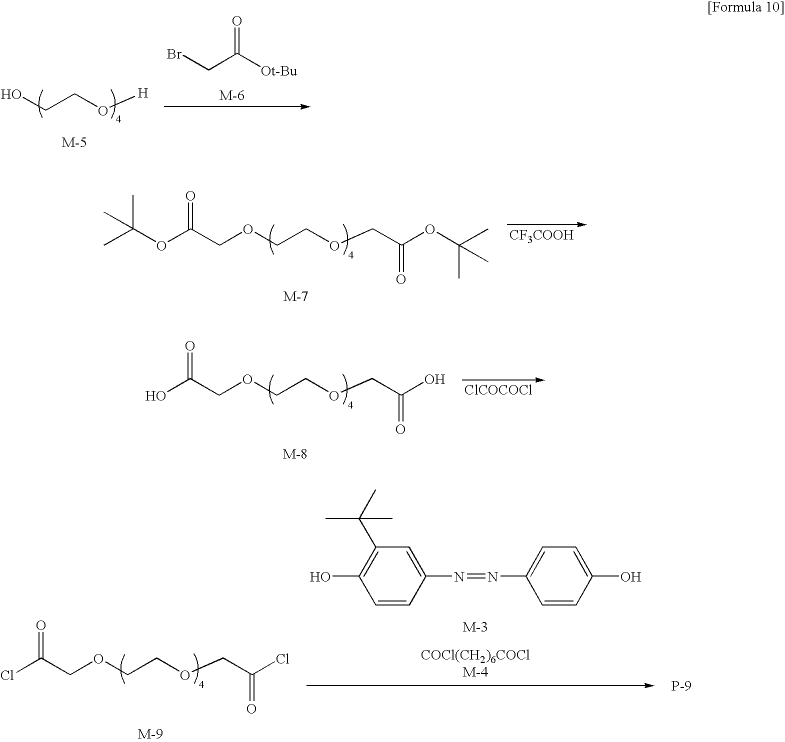

The mixture of M-5 (20.00 g, 0.103 mol), toluene (300 ml) and an aqueous solution of 48% by weight sodium hydroxide (300 ml) was cooled to 0° C., the salt of tetra-n-butylammonium hydrogensulfate (76.94 g, 0.227 mol) was added to the mixture, and M-6 (80.34 g) was added dropwise to the mixture while vigorously stirring the mixture. After stirring at 0° C. for 30 minutes, the mixture was warmed to room temperature and stirred for another 30 minutes. Water was added to the mixture to separate the organic layer, and the separated organic layer was washed with an aqueous solution of saturated ammonium chloride, an aqueous solution of saturated sodium hydrogencarbonate and an aqueous solution of saturated sodium chloride in this order. The washed organic layer was dried with magnesium sulfate and the solvent was distilled away. The residue thus obtained was purified by silica gel column chromatography (solvent: hexane/ethyl acetate/ethanol (10/10/1 (v/v/v)) to yield M-7 (15.23 g, 0.036 mol). To the M-7 (10.00 g, 0.024 mol), trifluoroacetic acid (40 ml) and methylene chloride (40 ml) were added and stirred at room temperature for 1 hour. The solvent was distilled away under vacuum to yield M-8 (7.44 g, 0.024 mol). Then the M-8 (7.44 g, 0.024 mol) was dissolved in methylene chloride (150 ml), and a solution of oxalic chloride in 2 M methylene chloride (72 ml, 0.144 mol) and dimethyl formamide (1 droplet with Pasteur pipette) were added to the solution at 0° C. Ten minutes after the addition, the mixed solution was warmed to room temperature and stirred for another 1 hour. The solvent was distilled away from the resultant reaction product to yield M-9 (7.5 g, 0.022 mols).

M-3 (2.703 g, 10 mmols) was dissolved in an aqueous solution of sodium hydroxide (sodium hydroxide: 0.8 μg, water: 100 ml), and to the resultant solution, tetra-n-butylammonium chloride (1.60 g, 5.76 mmols) was added. Then, a solution prepared by dissolving M-4 (1.794 g, 8.50 mmols) and M-9 (0.521 g, 1.50 mmols) in 1,2-dichloroethane (30 ml) was added dropwise over 30 minutes, while vigorously stirring the M-3 solution, and stirred vigorously for another 30 minutes. To the resultant reaction product, 20 ml of methylene chloride was added so as to separate the organic layer. The organic layer was washed with an aqueous solution of saturated sodium chloride and dried by adding magnesium sulfate. The solvent was distilled away to some extent to concentrate the organic layer, and the concentrated organic layer was added to methanol to be reprecipitated. The resultant precipitate was filtered and dried to yield P-9 (4.3 g). The weight average molecular weight of P-9 was determined, in terms of polystyrene, using GPC analyzer with columns TSK Gel GMHxL, TSK Gel G4000 H×L and TSK Gel G2000 H×L (trade names, all manufactured by Toso) and THF as a solvent, by differential refractometry. The determination was 88000.

### Example 3

### Synthesis of Photoresponsive Condensation Polymer P-15

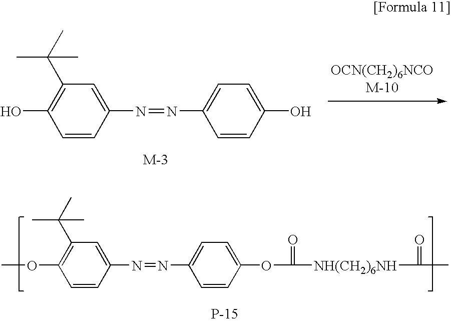

M-3 (8.04 g, 29.7 mmols) was dissolved in a chlorobenzene-dichlorobenzene mixed solvent (volume ratio 80:20) (100 ml). Hexamethylene isocyanate (5.00 g, 29.7 mmols) was dissolved in the same mixed solvent (50 ml) as above and about half amount of the solution was added to the M-3 solution in an atmosphere of nitrogen while heating under reflux and vigorously stirred. The rest of the solution of hexamethylene isocyanate was added dropwise over 3 to 4 hours, and after completing the addition, the resultant solution was heated under reflux for another 1 hour. The solution was then cooled to room temperature, and the produced precipitate was filtered out, washed with methanol, and dried to yield P-15 (10.3 g).

### Example 4

### Synthesis of Photoresponsive Condensation Polymer P-16

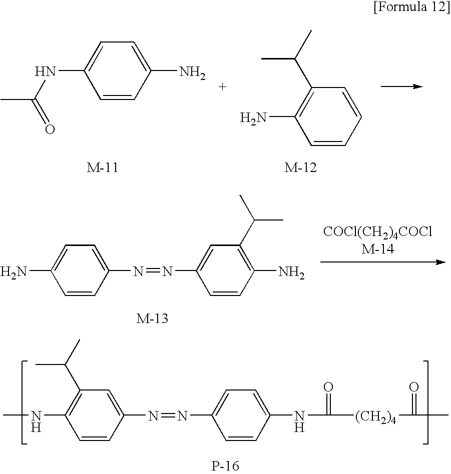

To an aqueous solution prepared by adding 90 ml of water to 22 ml of an aqueous solution of 37% by weight of hydrochloric acid, M-11 (15.02 g, 0.100 mols) was added and cooled to 5° C. or lower. To this solution, an aqueous solution prepared by dissolving 7.59 g of sodium nitrite in 22 ml of water was added dropwise (internal temperature was 5° C. or lower). The mixed solution was stirred for 30 minutes while keeping the internal temperature at 5° C. to 10° C. The resultant solution was added dropwise to an aqueous solution of methanol that contained M-12 (13.52 g, 0.100 mols) and sodium acetate (24.61 g, 0.300 mols), while keeping the internal temperature at 5° C. or lower, and the mixed solution was stirred for 30 minutes. The resultant reaction product was added to ethanol and the produced precipitate was filtered out and washed with ethanol. After drying, the resultant product was added to an aqueous solution of ethanol (ethanol: 100 ml, water: 200 ml) that contained potassium hydroxide (40 g) and the solution was heated under reflux for 5 hours. The solution was then cooled to room temperature, and concentrated hydrochloric acid was added to the solution to adjust the pH of the solution to 6. The produced precipitate was filtered out, washed with water and dried to yield M-13 (17.8 g, 70 mmols)

M-13 (2.54 g, 10 mmols) and sodium carbonate (2.12 g, 20 mmols) were dissolved in water (50 ml) and tetrahydrofuran (40 ml). A solution prepared by dissolving M-14 (1.83 g, 10 mmols) in tetrahydrofuran (20 ml) was added to the above solution at a time while vigorously stirring the solution and the resulting solution was stirred vigorously for another 10 minutes. The resultant solid was filtered, washed with water and dried to yield P-16 (3.2 g).

### Example 5

### Preparation of First and Second Optically-Driven Actuators

P-4 (0.5 g) was formed into film by hot-melt pressing at 160° C. and 5 MPa using pressing machine (MINI TEST PRESS-10, manufactured by TOYOSEIKI) to prepare a first optically-driven actuator (film of 88 μm thick, 1.0 cm×2.0 cm in size). The film obtained by the hot press was stretched at 60° C. at degree of uniaxial stretching of 2.0 to prepare a second optically-driven actuator (film of 60 μm thick, 1.0 cm×2.0 cm in size).

### (Evaluation of Photoresponsivity for First Optically-Driven Actuator)

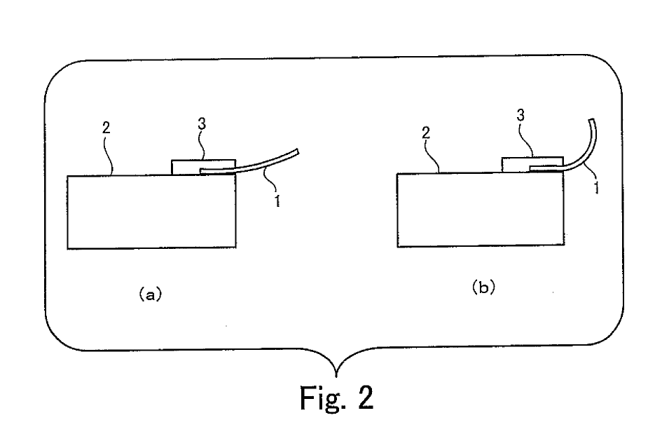

FIG. 2 is a diagram illustrating the evaluation experiment of photoresponsivity for the first optically-driven actuator in example 5 of the present invention.

Part (a) of FIG. 2 illustrates the state of the optically-driven actuator 1 before exposed to ultraviolet light. One end of the optically-driven actuator 1 was fixed on the edge of the top surface of the stand 2 with a clamp 3. The clamp 3 is made up of material that intercepts light.

Ultraviolet light emitted from an ultraviolet irradiator (EXECURE 3000, manufactured by HOYA CANDEO OPTRONICS) was transformed into linear polarized light through a sheet polarizer, and the linearly polarized light at an intensity of 100 mW/cm² (365 nm) was applied to the first optically-driven actuator 1 directly from above at room temperature.

Part (b) of FIG. 2 illustrates the state of the optically-driven actuator 1 after ultra violet radiation. As shown in part (b) of FIG. 2, the optically-driven actuator 1 in the horizontal state was bent across the transmission axis of the sheet polarizer in 18 seconds. This confirmed that the optically-driven actuator 1 was driven by the linearly polarized light and the direction in which the actuator 1 was bent could be controlled.

### (Evaluation of Photoresponsivity for Second Optically-Driven Actuator)

Ultraviolet light emitted from an ultraviolet irradiator (EXECURE 3000, manufactured by HOYA CANDEO OPTRONICS) at an intensity of 100 mW/cm² (365 nm) was applied to the second optically-driven actuator directly from above at room temperature in the same manner as in the evaluation experiment of photoresponsivity for the first optically-driven actuator.

As a result, the optically-driven actuator 1 in the horizontal state was bent in 5 seconds in the direction of uniaxial stretching.

In Example 5, the evaluations of the photoresponsivity for the first and second optically-driven actuators confirmed that the first and second optically-driven actuators were driven under optical stimulation.

### Example 6

### Preparation of Third Optically-Driven Actuator

P-7 (0.5 g) was formed into film by hot-melt pressing at 140° C. and 5 MPa using pressing machine (MINI TEST PRESS-10, manufactured by TOYOSEIKI). The film obtained by the hot press was stretched at room temperature at degree of uniaxial stretching of 2.0 to prepare a third optically-driven actuator (film of 50 μm thick, 1.2 cm×2.2 cm in size).

### (Preparation of Fourth Optically-Driven Actuator)

P-7 (200 mg) was dissolved in chloroform (500 μL) to prepare a coating fluid. The coating fluid was filtered through a microfilter (DISMIC-13 PTFE 0.45 mM, manufactured by ADVANTEC), coated on a quartz glass substrate by spin coating (1000 rpm, 20 seconds), dried at room temperature for 1 hour, and the film was separated from the glass substrate with a razor's edge to prepare a fourth optically-driven actuator (film of 22 μm thick, 0.4 cm×0.8 cm in size).

### (Evaluation of Photoresponsivity for Third Optically-Driven Actuator)

Ultraviolet light emitted from an ultraviolet irradiator (EXECURE 3000, manufactured by HOYA CANDEO OPTRONICS) at an intensity of 100 mW/cm² (365 nm) was applied to the third optically-driven actuator at room temperature in the same manner as in the evaluation experiment of photoresponsivity for the first optically-driven actuator. As a result, the optically-driven actuator in the horizontal state was bent in 5 seconds in the uniaxial direction that the actuator film was stretched. This confirmed that the third optically-driven actuator was driven by light.

### (Evaluation of Photoresponsivity for Forth Optically-Driven Actuator)

Ultraviolet light emitted from an ultraviolet irradiator (EXECURE 3000, manufactured by HOYA CANDEO OPTRONICS) at an intensity of 100 mW/cm² (365 nm) was applied to the fourth C optically-driven actuator directly from above at room temperature in the same manner as in the evaluation experiment of photoresponsivity for the first optically-driven actuator. As a result, the optically-driven actuator in the horizontal state was brought to the bent state in 10 seconds across the transmission axis of the sheet polarizer. This confirmed that the fourth optically-driven actuator was driven by linearly polarized light and the direction in which the actuator was bent could be controlled.

In Example 6, the evaluations of the photoresponsivity for the third and fourth optically-driven actuators confirmed that the third and fourth optically-driven actuators were driven under optical stimulation.

### Comparative Example

A self-supporting liquid-crystal elastomer film (film thickness=42 μm) was prepared from the monomer/crosslinking agent described below (composition: A6AB2/DA6AB=50/50 (mole ratio)) in accordance with the process described in Chem. Mater. vol. 16, p. 1637 (2004). The film was exposed to ultraviolet light at an intensity of 100 mW/cm² (365 nm) irradiated from an ultraviolet irradiator (EXECURE 3000, manufactured by HOYA CANDEO OPTRONICS) at 100° C. As a result, the film in the horizontal state was bent along the rubbing direction of the oriented film in 20 seconds. On the other hand, when the film was exposed to ultraviolet light at room temperature over 1 minute, there was observed no change in the form of the film.

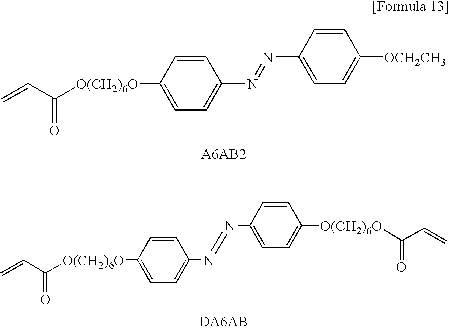

A6AB2: Compound described in Chem. Mater. vol. 16, p. 1637 (2004)
DA6AB: The same as above

Examples 5 and 6 and comparative example have proved that the optically-driven actuators of the present invention (the first to fourth actuators) are superior to the actuator composed of a polymer that has a photoisomerizable group on its side chain (comparative example) in that they are driven at room temperature. The examples and comparative example have also proved that the films having undergone stretching (the second and third optically-driven actuators) give the advantageous effect of high response speed.

As described so far, according to the present invention, it is possible to provide an optically-driven actuator that is highly photoresponsive, flexible and lightweight, and moreover, is driven noiselessly and an easy and simple method of manufacturing the same. It is also possible to provide a good polymer used for manufacturing the optically-driven actuator and a film made up of the polymer.

The optically-driven actuator of the present invention is applicable to active forceps, endoscopes, artificial muscles, drug delivery systems or biodevices in the field of medical/nursing care as well as driving parts of small size space probes, living-body imitating robots or artificial satellites in the field of aerospace. Further, it can be used in driving parts of ordinary equipment such as digital cameras, cellular phones, micropumps, touch displays or non-contact testers.

1. An optically-driven actuator comprising a polymer that deforms under optical stimulation and utilizing the deformation of the polymer for an actuator, the actuator comprising;
a condensation polymer containing, on a backbone chain thereof, a photoisomerizable group that undergoes structural change under optical stimulation and deforming depending on the structural change of the photoisomerizable group,
wherein the condensation polymer deforms depending on the optical stimulation and is functional as an actuator.

2. The optically-driven actuator according to claim 1, wherein the photoisomerizable group is an azobenzene group.

3. The optically-driven actuator according to claim 2, wherein the azobenzene group is represented by the following general formula (1): 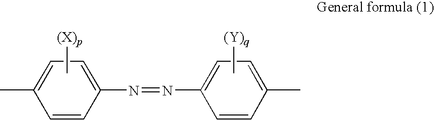
wherein X and Y each represent a substituent, other than a hydrogen atom, which can be substituted on a phenyl group; and p and q each represent an integer of 0 to 4, provided that p+q≠0 and when p (or q) is 2 or more, X (or Y) may be the same or different.

4. The optically-driven actuator according to claim 3, wherein at least one of the substituents X and Y in the general formula (1) is a branched alkyl group.

5. The optically-driven actuator according to any one of claims 1 to 4, wherein the condensation polymer is any one selected from the group consisting of polyesters, polyamides, polyurethanes and polycarbonates.

6. The optically-driven actuator according to claim 1, wherein the actuator is formed into a film.

7. The optically-driven actuator according to claim 1, wherein the actuator is formed into a film and has undergone stretching.

8. A method of manufacturing an optically-driven actuator comprising a polymer that deforms under optical stimulation and utilizing the deformation of the polymer for an actuator, the method comprising the steps of:
forming a film from a composition comprising a condensation polymer that has a photoisomerizable group on a backbone chain thereof; and
stretching the composition comprising the condensation polymer.

9. A condensation polymer comprising, on a backbone chain thereof.
a photoisomerizable group that undergoes structural change under optical stimulation and deforming depending on the structural change of the photoisomerizable group,
wherein the condensation polymer has a repeating unit represented by the following general formula (2): 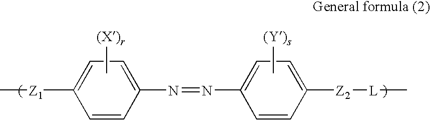
wherein X′ and Y′ each represent a substituent, other than a hydrogen atom, which can be substituted on a phenyl group and at least one of X′ and Y′ is a branched alkyl group; r and s each represent an integer of 0 to 4, provided that r+s≠0 and when r (or s) is 2 or more, X′ (or Y′) may be the same or different; L represents a divalent linking group or a single bond; and Z₁ represents a divalent linking group selected from the group consisting of —OC(═O)—, —OC(═O)NR¹—, —C(═O)NR¹—, where R¹ is a hydrogen atom or an optionally substituted alkyl group, and where these divalent linking groups may be linked in either direction, and Z₂ represents a divalent substituent linked in the direction opposite to Z₁.

10. A film comprising the condensation polymer according to claim 9.
